(19) United States
(12) Patent Application Publication
(10) Pub. No.: US 2010/0216334 A1
(43) Pub. Date: Aug. 26, 2010

(54) Electrical Service Device

(75) Inventors: Jürgen Christmann, Bammental (DE); Ralf Weber, Heidelberg (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/086,215

(22) PCT Filed: Nov. 29, 2006
(86) PCT No.: PCT/EP2006/011442

§ 371 Date: Jun. 17, 2008

(30) Foreign Application Priority Data
Dec. 17, 2005 (DE) 10 2005 060 585.0

(51) Int. Cl. H01R 13/60

(52) U.S. Cl. 439/532

(57) ABSTRACT

Electrical service device having a cutout, which is arranged on an attachment face and at one end of which a movable lug is arranged, which lug can be latched in behind a longitudinal edge of a top-hat rail, wherein the movable lug is integrally formed on a latching arm, which protrudes on the attachment face at right angles thereto, and wherein a groove, which is open toward the movable lug, is arranged at the other end of the cutout, in such a way that, in the fitted state, one longitudinal edge of the top-hat rail is inserted behind the movable lug, and the other longitudinal edge is inserted into the groove. Furthermore, a spring element is provided which, once the service device has been fitted, presses in a sprung manner against the top-hat rail.

The invention relates to an electrical service device in accordance with the precharacterizing clause of claim 1.

Service distribution boxes, in particular domestic service distribution boxes, accommodate those service switching devices which are necessary, for example, for a domestic installation. These are, for example, line circuit breakers, residual current circuit breakers or the like. In these service distribution boxes, top-hat rails are arranged so as to hold the service devices, which top-hat rails run horizontally and of which normally two top-hat mounting rails arranged one on top of the other are provided. Such top-hat mounting rails have a U-shaped basic body; strips which are bent back towards the outside and lie in a plane which runs parallel to the web of the U-shape are integrally formed on the limb ends. The service devices (reference is made by way of example to line circuit breakers) have a cutout on their fixing plane, in which cutout a stationary tab and a movable tab are located. Both tabs point towards one another and, for fitting purposes, the line circuit breaker is suspended with its stationary tab behind the upper longitudinal edge of the top-hat mounting rail and then the line circuit breaker is moved towards the top-hat rail, the movable tab first being pushed away by the lower longitudinal edge of the top-hat mounting rail and then latching into its end position behind the lower longitudinal edge. In this case, the top-hat mounting rail is arranged within the service distribution board in such a way that the faces of the strips or the web of the U shape are aligned vertically with respect to one another.

Similar arrangements are also provided in low-voltage switchgear assemblies, in which top-hat mounting rails are located, for example, in specific regions, onto which top-hat mounting rails the electrical service devices are latched or snapped, which also applies to motor circuit breakers, and control and regulating devices, in addition to the line circuit breakers and residual current circuit breakers. In the majority of service devices, an elongate slide, on whose end which protrudes into the cutout the movable tab is integrally formed or arranged, is located on the fixing face. In this case, the slide is under the pressure of a spring, which presses the slide in the direction towards the stationary tab. In this case, the slide can be produced from sheet steel or from plastic.

The object of the invention is to further improve a service device of the type mentioned at the outset in terms of its rapid fixing to a top-hat mounting rail.

This object is achieved according to the invention by the features of claim 1.

Further advantageous configurations of the invention are given in the dependent claims.

The invention and further advantageous configurations and improvements and further advantages are explained and described in more detail with reference to the drawing, in which two embodiments of the invention are illustrated and in which:

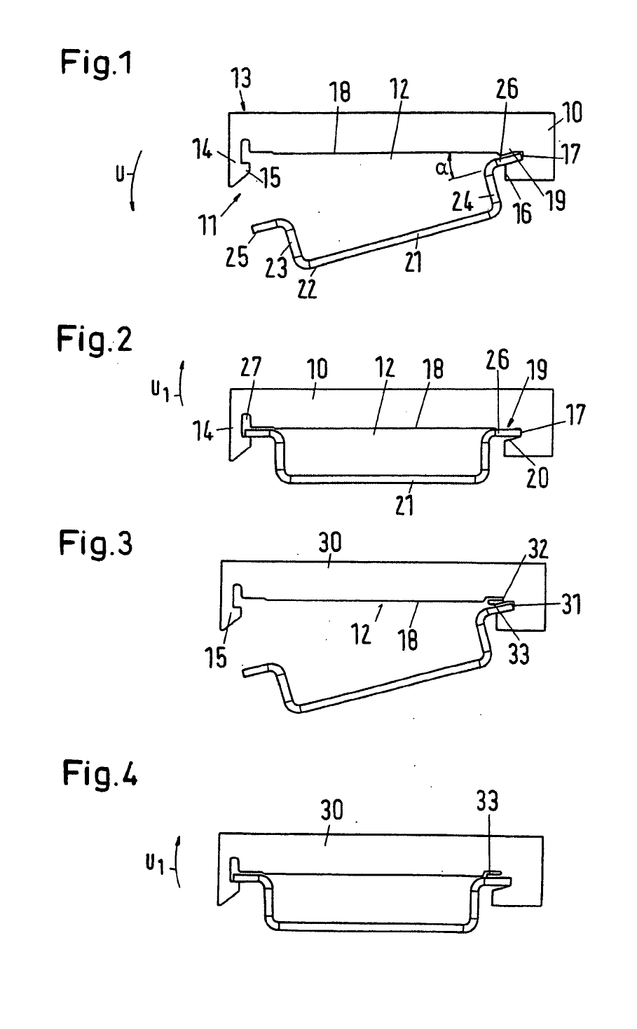

FIG. 1 shows an electrical service device in accordance with a first embodiment prior to the latching-on,

FIG. 2 shows the arrangement shown in FIG. 1 after the latching-on, and

FIGS. 3 and 4 show a further embodiment of the invention in the fitting positions corresponding to FIG. 1 and FIG. 2.

An electrical service device 10, which may be, for example, a line circuit breaker, has an approximately U-shaped cutout 12 on its fixing face 11, on one end of which cutout a sprung latching arm 14 is integrally formed in the region 13, which latching arm bears a movable latching tab 15; the sprung latching arm 14 to this extent forms one wall of the cutout 12.

A groove 17, which is open towards the movable tab 15, is provided on the opposite wall 16 of the cutout. The groove 17 is U-shaped, its longitudinal extent forming a certain acute angle α with respect to the fixing face 11 or with respect to the base surface 18 of the cutout 12. As a result, a projection 19, based on the base surface 18, is formed in the region of the groove 17 on the base surface 18 of the cutout 12; the other wall 20 of the groove 17 likewise forms the angle α with the base surface 18.

The service device 10 is snapped onto a top-hat mounting rail 21 which has a U-shaped basic body 22, flange strips 25 and 26, which are bent back outwards, being integrally formed on the ends of the limbs 23 and 24.

For fitting purposes, the service device 10 is suspended with the groove 17 over the longitudinal edge of the flange strip 26, with the result that the flange strip 26 is located within the groove 17. Thus, the service device 10 and the groove 17 are joggled in the arrow direction U until the flange strip 25 with its longitudinal edge engages behind the movable tab 15 of the latching arm 14. In order that the latching arm 14 has an improved spring characteristic, a depression 27, which runs at right angles with respect to the base surface 18, is provided in the base surface 18 of the cutout 12 in the region of the latching arm, with the result that the spring arm of the latching arm 14 is enlarged.

The projection 19 is then pressed in a sprung manner flat by means of the flange strip 26; as a result, a force is exerted on the top-hat mounting rail 21 via the projection 19, which top-hat mounting rail attempts to rotate the service device 10 in the clockwise direction U₁ around the groove 17, as a result of which a tensile force is exerted on the latching arm 14.

In the embodiment shown in FIG. 3 and FIG. 4, in the same way a depression 12 is provided on a service device 30 on its fixing side, at that end of the depression which is opposite the movable tab 15, a groove 31 being provided whose wall 32, which is located in the region of the base surface 18, is formed by a spring arm 33, which projects approximately from the groove base of the groove 31 in the direction towards the movable tab 15; in the case of fitting, this spring arm 33 is deformed, as is the projection 19, with the result that the spring arm 33 exerts a force on the service device 30 which bends the latter in the same as in the embodiment shown in FIG. 2 in the arrow direction U1 to pivot viewed.

1. An electrical service device with a cutout which is arranged on a fixing face and at whose one end a movable tab is arranged, which can be latched in behind a longitudinal edge of a top-hat mounting rail, wherein the movable tab is integrally formed on a latching arm, which projects on the fixing face at right angles with respect thereto, and in that at the other end of the cutout a groove, which is open towards the movable tab, is arranged in such a way that, in the fitted state, one longitudinal edge of the top-hat mounting rail is inserted behind the movable tab and the other longitudinal edge is inserted into the groove.

2. The service device as claimed in claim 1, wherein a spring element is provided on a wall of the groove, which spring element, after fitting of the service device, presses in a resilient manner against the flange strip of the top-hat mounting rail.

3. The electrical service device as claimed in claim 2, wherein the spring element is arranged on the side of the fixing plane of the flange strips of the top-hat mounting rail.

4. The service device as claimed in claim 3, wherein the spring element is a projection, which protrudes into the groove transversely with respect to its opening direction and protrudes beyond the base surface of the cutouts.

5. The electrical service device as claimed in claim 3, wherein the spring element is a spring arm, which is arranged in the region of the base surface of the cutouts, projects in a direction towards the movable tab, in the non-fitted state protrudes beyond the base surface and in the fitted state lies in the plane formed by the base surface.
